(19) United States
(12) Patent Application Publication
(10) Pub. No.: US 2021/0123260 A1
(43) Pub. Date: Apr. 29, 2021

(54) Campfire Reflective Barrier

(71) Applicant: Clayton Thompson, Edmonton (CA)

(72) Inventor: Clayton Thompson, Edmonton (CA)

(21) Appl. No.: 16/660,979

(22) Filed: Oct. 23, 2019

(51) Int. Cl. E04H 15/00; E04H 17/18

(52) U.S. Cl. CPC E04H 15/005; E04H 17/18

(57) ABSTRACT

A campfire reflective barrier for protecting a user from exposure to wind while concurrently providing heat reflection from a campfire or other associated energy sources is provided. The campfire reflective barrier includes a first panel affixed to an adjacent second panel via a hinge. The panels form a heat reflecting and wind deflecting shield. Each panel includes a first side having a heat reflecting element that can reflect heat and a second side for deflecting wind. In one embodiment, the heat reflecting element is formed in a bubble arrangement to provide a highly reflective surface so as so reflect the heat generated by the campfire. In some embodiments, the panels are reconfigurable and joinable with other campfire reflective barriers to form a continuous shield.

### BACKGROUND OF THE INVENTION

The present invention relates to campfire reflective barriers. More specifically, the present invention relates to a campfire reflective barrier having heat reflecting material on a first side of a panel and a living hinge that joins adjacent panels. Further, the campfire reflective barrier is reconfigurable and modular with other similar campfire reflective barriers.

In cool weather camping conditions, parts of a person's body not facing the radiant heat from a campfire will feel cold and uncomfortable. Further, many people typically congregate around the campfire and inadvertently prevent the radiant heat from reaching all of the congregates. As an attempt to overcome this, some people choose to wear more clothing or to wrap oneself in a blanket. However, there are situations where campers or other outdoor enthusiasts wish to not be burdened with bulky coats and blankets. Alternatively, less bulky thermal underclothing can be worn. However, wearing thermal underclothing has the disadvantage of not being easily removed once fully dressed. As a result, fluctuation in temperature causes excess warmth, leading to sweating and other uncomfortable body adaptations.

When using an open fire for warmth, the body absorbs heat where exposed to the fire, but radiates heat where unexposed portions of the body are unprotected. Attempts have been made to solve this problem. However, these devices fail to adequately provide for an easy-to-use modular setup and a workable arrangement. For example, one of these existing campfire reflective barriers provides a reflective panel that is mountable to the backrest of a chair and to the bottom rail between the two front legs of the chair thereby reflecting the radiant heat in an upward direction warming those parts of a person's body not normally receiving heat. Unfortunately, these existing devices fail to provide a more comprehensive solution as much radiant heat is not directed to the reflective portions which is blocked by the chair and seated user. Additionally, these devices require an additional structure, such as a chair, to mount thereon.

In view of the above concerns, there is a need to provide a campfire reflective barrier for mounting in any configuration about a campfire so as to reflect heat towards the user when oriented toward the campfire. The campfire reflective barriers include a flexible hinge that joins adjacent panels forming a continuous interior side and provides for securement to the ground via stakes that pass through the hinge. This will allow for assembly in any shape and size about a campfire, which will not only reduce the need for extraneous structures for mounting thereto but will reduce setup time by being reconfigurable in any position around the campfire. The exterior of the panels shields the user from wind chill and provides a barrier that keeps a user within the confines of the campfire area.

In addition, there is a need for a device that joins with other substantially similar campfire reflective barriers to selectively adjust the number of panels. In this way, the campfire reflective barrier is usable for any number of users and campfire area sizes.

In light of the devices disclosed in the known art, it is submitted that the present invention substantially diverges in design elements and methods from the known art and consequently it is clear that there is a need in the art for an improvement for a campfire reflective barrier. In this regard the instant invention substantially fulfills these needs.

### SUMMARY OF THE INVENTION

In view of the foregoing disadvantages inherent in the known types of campfire reflective barriers now present in the known art, the present invention provides a new campfire reflective barrier wherein the same can be utilized for encompassing a campfire to reflect and retain heat within the protected area.

It is an objective of the present invention to provide a campfire reflective barrier having a first panel affixed to an adjacent second panel via a hinge. The panels are configured to form a heat reflecting and wind deflecting shield. Each panel comprises a first side having a heat reflecting element configured to reflect heat and a second side for deflecting wind. In one embodiment, the heat reflecting element is Mylar® formed in a bubble arrangement. The Mylar® material provides a highly reflective surface so as so reflect the heat generated by the campfire.

It is another object of the present invention to provide a modular campfire reflective barrier that is reconfigurable and joinable with other campfire reflective barriers to form a continuous shield.

It is yet another embodiment of the present invention to provide a campfire reflective barrier comprising the heat reflecting element in a bubble arrangement, wherein the bubble arrangement does not focus an excess of radiant heat to a single area. The radiant heat from a point source, such as a fireplace, is scattered and provides for even thermal distribution within the enclosed area.

It is therefore an object of the present invention to provide a new and improved campfire reflective barrier.

It is an objective of the present invention to provide that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the campfire reflective barrier.

FIG. 2 shows a perspective view of an embodiment of the campfire reflective barrier positioned about a campfire.

FIG. 3 shows a cross-sectional view of an embodiment of the panel of the campfire reflective barrier.

FIG. 4A shows a perspective view of an embodiment of the campfire reflective barrier in a rolled configuration.

FIG. 4B shows a perspective view of an embodiment of the campfire reflective barrier in a stacked configuration.

### DETAILED DESCRIPTION OF THE INVENTION

Reference is made herein to the attached drawings. Like reference numerals are used throughout the drawings to depict like or similar elements of the campfire reflective barriers. For the purposes of presenting a brief and clear description of the present invention, the preferred embodiment will be discussed as used for retaining campfire heat within a protected area formed by the campfire reflective barriers. The figures are intended for representative purposes only and should not be considered to be limiting in any respect.

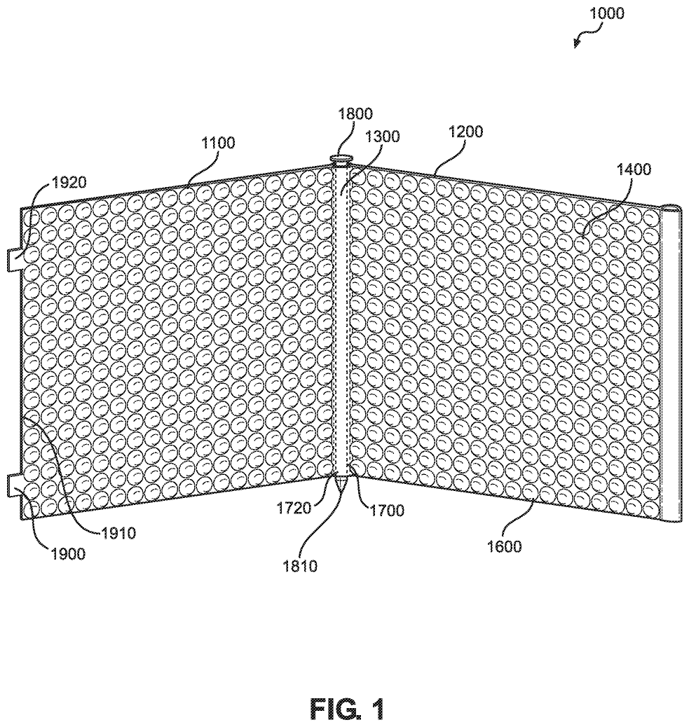

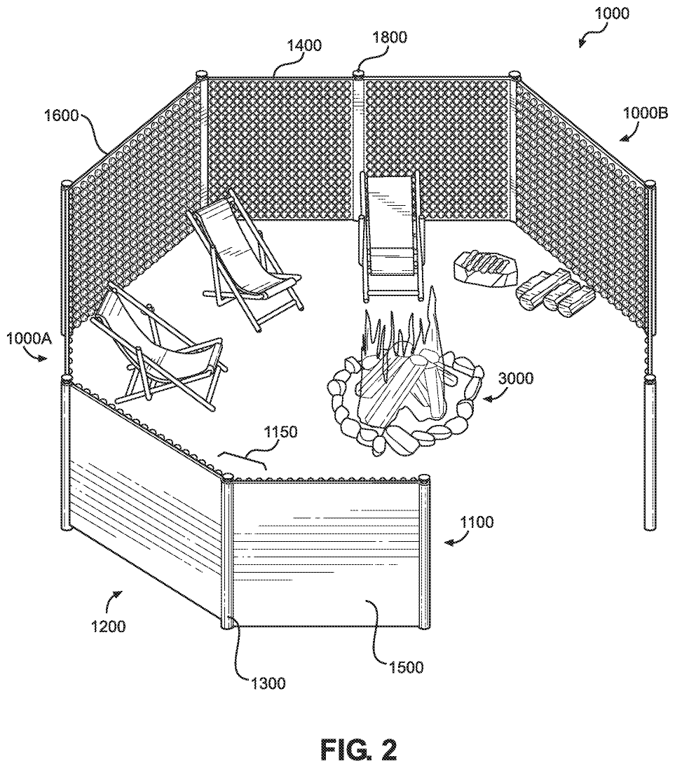

Referring now to FIGS. 1 and 2, there is shown a perspective view of an embodiment of the campfire reflective barrier and a perspective view of an embodiment of the campfire reflective barrier positioned about a campfire, respectively. The campfire reflective barrier 1000 reflects and retains heat within a desired area, typically around a campfire. The campfire reflective barrier 1000 comprises a first panel 1100 affixed to an adjacent second panel 1200 via a hinge 1300, forming a heat reflecting and wind deflecting shield. Each panel 1100, 1200 comprises a first side 1400 and a second side 1500, wherein the first side 1400 includes a heat reflecting element 1600 configured to reflect heat. In one embodiment, the heat reflecting element 1600 comprises a BoPET or biaxially-oriented polyethylene terephthalate material, such as Mylar®, formed in a bubble arrangement. The Mylar® material provides a highly reflective surface so as so reflect the heat generated by the campfire.

In the shown embodiment, the hinge 1300 comprises a sleeve 1700 extending along an entirely length thereof and formed by a pair of fabric members. In the illustrated embodiment, the sleeve 1700 comprises a first fabric member extends between the first and second panels 1100, 1200 along the first side 1400 and a second fabric member extends between the first and second panels 1100, 1200 along the second side 1500. The sleeve 1700 is hollow and adapted to receive a stake 1800 through an open upper end 1710 and traverse the entire length of the sleeve 1700 so as to extend past a lower open end 1720. In this way, the stake 1800 is selectively driven into the ground to secure the campfire reflective barrier 1000 in a vertical position. In the vertical position, the campfire reflective barrier 1000 is perpendicular to the ground surface and thereby provides the most effective wind deflection and heat reflecting. The hinge 1300 allows a user to selectively alter the angle of each panel 1100, 1200 relative to each other about the hinge 1300, and relative to the ground. Thus, the campfire reflective barrier 1000 is reconfigurable so as to provide the most effective wind deflection and heat reflecting. In one embodiment, the campfire reflective barrier 1000 comprises at least three panels arranged so as to completely encompass a campfire and forming a protected interior area.

In the shown embodiment, each panel 1100, 1200 comprises a rectangular shape. However, in alternative embodiments, the shape of each panel 1100, 1200 may be any size or shape known in the art, such as, but not limited to squares, circles, or trapezoids. In the shown embodiment, each panel 1100, 1200 measures four feet by four feet. However, in alternative embodiments, each panel 1100, 1200 may have any dimension. Additionally, in the shown embodiments, each panel 1100, 1200 is a rigid planar member. However, in alternative embodiments, the panels 1100, 1200 are arcuate so as to form a concave and/or convex shape.

In some embodiments, the present invention is configured as a single row of panels 1100, 1200, generally arranged in wall. However, in other embodiments, the present invention forms one or more connected rows of panels. In such embodiments, any configuration of panels, such as, but not limited to, an arc or a zig-zag pattern (alternating “V” shaped sections). In the shown embodiments, the first panel 1100 forms a selective angle 1150 with the second panel 1200, wherein the selective angle 1150 is formed about the hinge 1300. Moreover, although generally contemplated to be configured to connect lateral side to lateral side, one or more campfire reflective barriers 1000 may be configured to be stackable, or to be connected vertically. In this way, the sleeves 1700 would be aligned so as to receive a stake 1800 of double length and that the first side 1400 of the multiple campfire reflective barriers are oriented in the same direction. In some embodiments, the various barrier panels may not be of uniform size.

As seen in FIG. 1, each panel 1100, 1200 includes a mating fastener 1900 disposed on a lateral end 1910 of the campfire reflective barrier 1000. The fastener 1900 is adapted to secure to a panel 1100 of a second campfire reflective barrier 1000B. In this way, the campfire reflective barrier 1000 is modular and reconfigurable. In the illustrated embodiment, the mating fastener comprises a tab 1920 disposed on the first panel opposite the sleeve 1700 and a recess disposed on the second panel opposite the sleeve 1700, wherein the recess is configured to receive the tab therein. When the first campfire reflective barrier is aligned with the second campfire barrier, the tab and recess align so as to form a friction fit with one another. In other embodiments, the mating fastener forms an interlocking configuration, such as a clip. When the connected, a lateral side of the first campfire barrier rests flush against a lateral side of the second campfire barrier.

In one exemplary use as seen in FIG. 2, the campfire reflective barrier 1000 is positioned about a campfire 3000. The campfire reflective barrier 1000 includes a first and second campfire reflective barrier 1000A, 1000B coupled via the fasteners and positioned to form a continuous shield. Each campfire reflective barrier 1000A is secured via the stake 1800 driven into the ground surface wherein the first side 1400 having the heat reflective element 1600 is facing the campfire 3000. In the shown embodiment, the stake 1800 comprises a tip 1810 adapted to pierce a ground surface and orient the campfire reflective barrier 1000 in an upright position. In alternative embodiment, the campfire reflective barrier 1000 comprises more than two panels 1100, 1200, wherein each additional panel is joined with the adjacent panel via the hinge 1300 of FIG. 1.

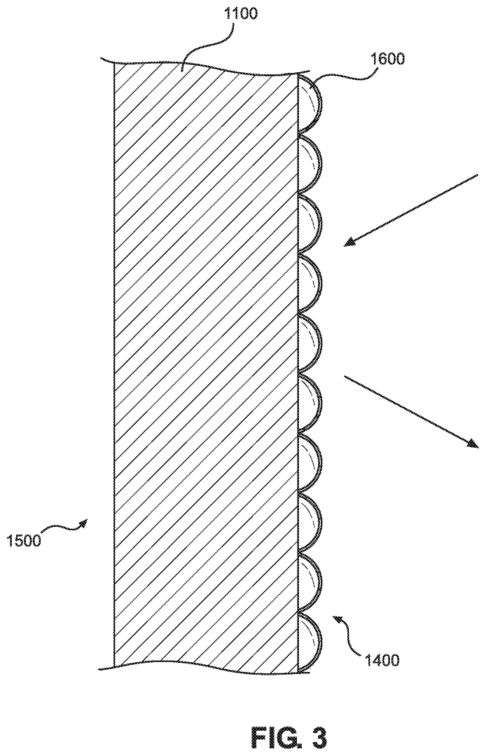

Referring now to FIG. 3, there is shown a cross-sectional view of an embodiment of the panel of the campfire reflective barrier. In the shown embodiment, the heat reflecting element 1600 is positioned on the first side 1400 of the panel 1100. In one embodiment, the heat reflecting element 1600 comprises a Mylar® material formed in a bubble arrangement. The bubble arrangement provides compartments of air or other fluid trapped therein to provide additional insulation. In the shown embodiment, bubble arrangement is of uniform pattern. However, in alternative embodiments, the bubble arrangement may form an alternative pattern or be random. The Mylar® material provides a highly reflective surface so as so reflect the heat generated by the campfire.

As heat radiates from the campfire, the heat is redirected at an angle equal to the angle of incidence. The bubble arrangement of the Mylar® causes a scattering of the heat within the enclosed area. In this way, the bubble arrangement does not focus an excess of radiant heat on a single area. The scattering of the radiant heat throughout the area provides for even thermal distribution within the enclosed area.

In the shown embodiment, the second side 1500 of the panel 1100 is adapted to deflect wind from passing through to the enclosed area on the first side 1400. In one embodiment, the panel 1100 comprises an impermeable material. In another embodiment, the layer of the heat reflecting element 1600 comprises more than half of the width of the panel 1100, wherein the width is measured as the distance between the lateral sides of the panels 1100 or is the width measured as a distance between the first and second side.

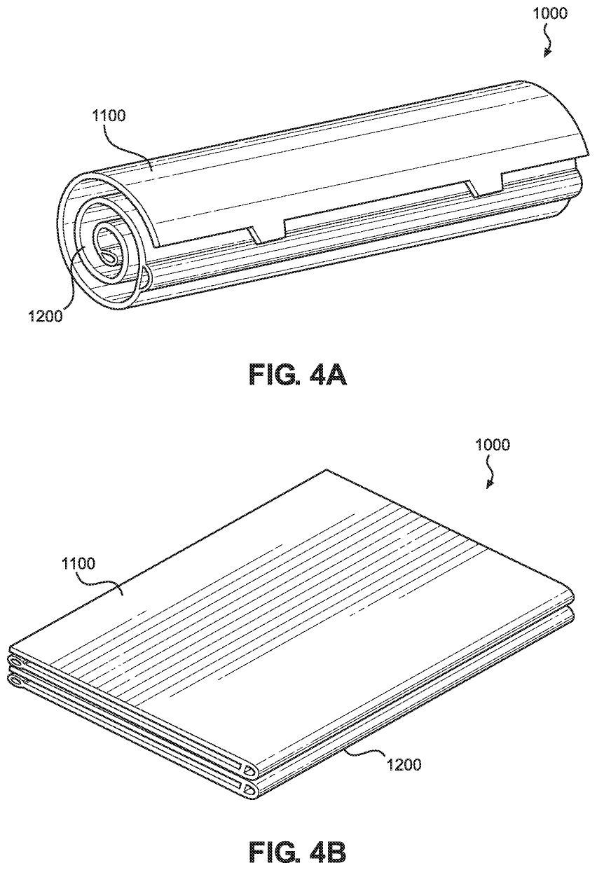

Referring now to FIGS. 4A and 4B, there is shown a perspective view of an embodiment of the campfire reflective barrier in a rolled configuration and a stacked configuration, respectively. In the embodiment shown in FIG. 4A, the panels 1100, 1200 are flexible and adapted to form a rolled configuration. The rolled configuration comprises a spiral shape. In this way, an elongated pouch can receive the rolled campfire reflective barrier for convenient portability. Alternatively, the campfire reflective barrier comprises 1000 a fastener or strap that is adapted to secure the panels in the rolled configuration.

In the embodiment shown in FIG. 4B, the panels 1100, 1200 are rigid so as to fold on top on one another about the sleeve to form a stacked configuration. The stacked configuration is desirable for transporting and storing multiple panels and multiple campfire reflective barriers in a compact manner. In other embodiments, the panels are composed of a material that allows a user to selectively roll or fold the campfire reflective barrier depending on the carrying and storing preference of the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A campfire reflective barrier, comprising:
a first panel affixed to an adjacent second panel via a hinge;
wherein each panel comprises a first side and a second side, wherein the first side includes a heat reflecting element configured to reflect heat;
wherein the hinge comprises a sleeve extending along an entire length thereof, the sleeve adapted to receive a stake therethrough.

2. The campfire reflective barrier of claim 1, wherein the stake comprises a tip adapted to pierce a ground surface and orient the campfire reflective barrier in an upright position.

3. The campfire reflective barrier of claim 1, wherein the first panel is configured to selectively form plurality of angles with the second panel, wherein the angles are formed about the hinge.

4. The campfire reflective barrier of claim 1, wherein the campfire reflective barrier is modular, wherein the first panel includes a fastener adapted to secure to a second campfire reflective barrier.

5. The campfire reflective barrier of claim 4, wherein the fastener comprises a tab disposed on a first campfire reflective barrier and a recess is disposed on the second campfire reflective barrier, wherein the recess is configured to receive the tab therein.

6. The campfire reflective barrier of claim 1, wherein the sleeve comprises an open upper end and an open lower end.

7. The campfire reflective barrier of claim 1, wherein the campfire reflective barrier comprises panels arranged so as to completely encompass a campfire and forming a protected interior area.

8. The campfire reflective barrier of claim 1, wherein the first side comprises Mylar®, wherein the Mylar® is disposed in a bubble arrangement.

9. The campfire reflective barrier of claim 1, wherein the first side is entirely covered with the heat reflecting element.

10. The campfire reflective barrier of claim 1, wherein each panel is entirely planar and rigid.

11. The campfire reflective barrier of claim 1, wherein the campfire reflective barrier is foldable about the hinge so as to store in a stacked configuration.

12. The campfire reflective barrier of claim 1, wherein the campfire reflective barrier is rollable such that each panel and the hinge is flexible so as to store in a rolled configuration.

13. The campfire reflective barrier of claim 1, wherein the heat reflecting element comprises more than half of the width of the first panel.
